(19) United States
(12) Patent Application Publication
(10) Pub. No.: US 2018/0019644 A1
(43) Pub. Date: Jan. 18, 2018

(54) GEAR STRUCTURE AND SERVO MOTOR

(71) Applicant: Sharp Kabushiki Kaisha, Sakai City, Osaka (JP)

(72) Inventors: Kazushi OKADA, Sakai City (JP); Hiroyuki UENO, Sakai City (JP); Tai MIYAGAWA, Sakai City (JP)

(21) Appl. No.: 15/538,312

(22) PCT Filed: Dec. 10, 2015
(86) PCT No.: PCT/JP2015/084660

§ 371 Date: Jun. 21, 2017

(30) Foreign Application Priority Data
Dec. 26, 2014 (JP) 2014-266341

(51) Int. Cl. H02K 7/116; F16H 55/06; F16H 57/032; F16H 1/20; F16H 57/02

(52) U.S. Cl. CPC H02K 11/022; H02K 7/116; F16H 57/032; F16H 1/20; F16H 55/06; F16H 2057/02034

(57) ABSTRACT

An embodiment of the present invention stably eliminates high-frequency electromagnetic noise in a servo motor. A gear structure (10) includes: a first metal gear (1); a second metal gear (2); a first metal member (second housing 4b, motor bearing section 4c) electrically continuous with the first metal gear (1); a second metal member (shaft part 2a) electrically continuous with the second metal gear (2); and an electrical connector (conductive gasket 9) electrically connecting the first metal member and the second metal member to each other.

### TECHNICAL FIELD

The present invention relates to a gear structure which eliminates generation of high-frequency electromagnetic noise and a servo motor including the gear structure.

### BACKGROUND ART

Conventionally, techniques for suppressing electromagnetic noise generated by servo motors have been studied. For example, Patent Literature 1 discloses a motor with a decelerator. This motor includes an electrical motor provided with an electromagnetic shield for suppressing influence caused by electromagnetic noise, and a decelerating mechanism connected to a rotary shaft of the electrical motor. This motor with a decelerator achieves suppression of electromagnetic noise generated by the electrical motor.

### CITATION LIST

### Patent Literature

[Patent Literature 1] Japanese Patent Application Publication, Tokukai, No. 2011-234489 (Publication date: Nov. 17, 2011)

### SUMMARY OF INVENTION

### Technical Problem

However, in the motor with a decelerator disclosed in Patent Literature 1, there is no measure taken for eliminating electromagnetic noise which is generated in the decelerating mechanism, more specifically, in the vicinity of a position where a worm and a worm wheel are in contact with each other, and/or in the vicinity of a position where metal gears for deceleration are in contact with each other. The electromagnetic noise which is generated in the vicinity of the above contact position(s) is repeatedly produced due to friction and/or an impact between teeth of gears that are engaged with each other. Further, this electromagnetic noise does not have specific frequency components, and is measured in a very wide band. On this account, particularly, in a case where a transmission antenna of a communication device is provided in the vicinity of the above contact position, a high-frequency component of the electromagnetic noise tends to fall into a reception band. This leads to a problem that noise in the reception band is likely to be generated.

An embodiment of the present invention is attained in view of the above problem. An object of an embodiment of the present invention is to stably eliminate generation of high-frequency electromagnetic noise by taking a direct measure to eliminate generation of high-frequency electromagnetic noise in a source of high-frequency electromagnetic noise, that is, in the vicinity of a position where metal gears are in contact with each other.

### Solution to Problem

In order to solve the above problem, a gear structure in accordance with an aspect of the present invention includes: a first metal gear contained in a first housing; a second metal gear that rotates in conjunction with the first metal gear in the first housing; a first metal member electrically continuous with the first metal gear; a second metal member electrically continuous with the second metal gear; and an electrical connector electrically connecting the first metal member and the second metal member to each other.

### Advantageous Effects of Invention

An aspect of the present invention makes it possible to stably eliminate high-frequency electromagnetic noise which is generated in the vicinity of a position where two metal gears are in contact with each other.

### BRIEF DESCRIPTION OF DRAWINGS

FIG. 1 is a cross sectional view illustrating a schematic configuration of a servo motor in accordance with Embodiment 1 of the present invention.

FIG. 2 is a schematic view illustrating an example of an experiment for measuring high-frequency electromagnetic noise in a case where the servo motor is adjacent to a transmission antenna of a communication device.

FIG. 3 is a graph showing a spectral line of a communication wave in a case where a servo motor employed does not include a gear structure in accordance with Embodiment 1 of the present invention.

FIG. 4 is a graph showing a spectral line of a communication wave in a case where a servo motor employed includes a gear structure in accordance with Embodiment 1 of the present invention.

FIG. 5 is a cross sectional view illustrating a schematic configuration of a modified example of the servo motor.

FIG. 6 is a cross sectional view illustrating a schematic configuration of a servo motor in accordance with Embodiment 2 of the present invention.

FIG. 7 is a cross sectional view illustrating a schematic configuration of a modified example of the servo motor.

FIG. 8 is a cross sectional view illustrating a schematic configuration of a servo motor in accordance with Embodiment 3 of the present invention.

FIG. 9 is a cross sectional view illustrating a schematic configuration of a modified example of the servo motor.

### DESCRIPTION OF EMBODIMENTS

### Embodiment 1

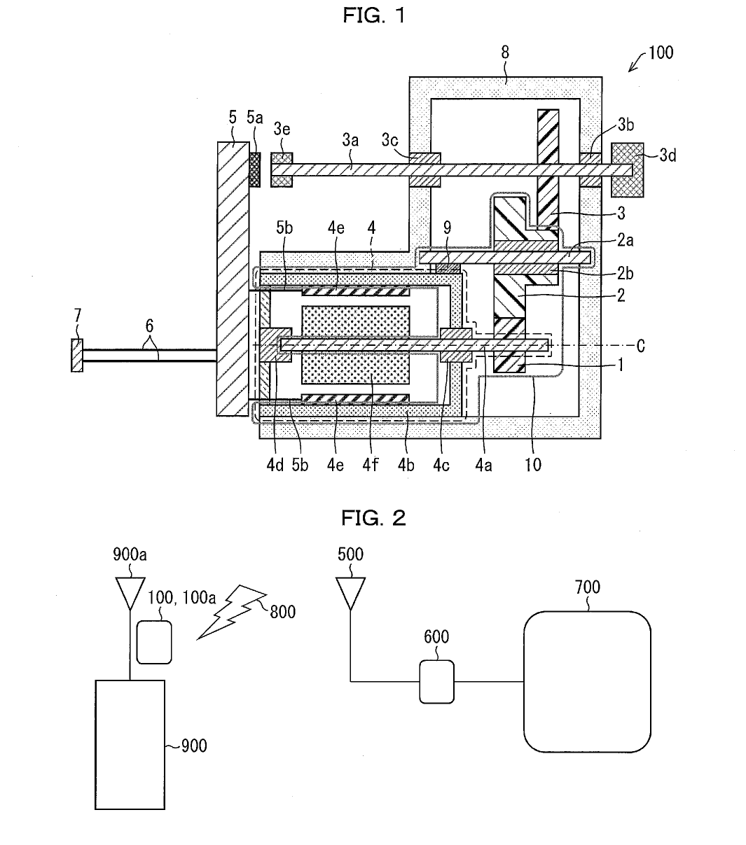

The following description will discuss an embodiment of the present invention, with reference to FIGS. 1 to 4.

<Configuration of Servo Motor 100>

FIG. 1 is a cross sectional view illustrating a schematic configuration of a servo motor 100 in accordance with an embodiment of the present invention. The servo motor 100 is intended to drive a movable part (not illustrated) of a bipedal walking robot. Note that an object to which the servo motor 100 is applied is not limited to a bipedal walking robot as in Embodiment 1, and can also be applied to, for example, radio control devices, white goods, etc.

As illustrated in FIG. 1, the servo motor 100 includes a first metal gear 1, a second metal gear 2, a shaft part 2a, a third metal gear 3, a shaft part 3a, bearing sections 3b and 3c, a servo horn 3d, a potentionmeter 5a, a motor main body 4, a first housing 8 and a conductive gasket (electrical connector) 9. In the first housing 8, the first metal gear 1, the second metal gear 2, the third metal gear 3, the motor main body 4 and the conductive gasket 9 are contained. Further, the first housing 8 is made of resin. Since the first housing 8 is made of resin, the weight and the cost of the servo motor 100 can be reduced as compared to a case where the first housing 8 contains metal as a material. However, the material of the first housing 8 is not limited to resin. For example, the first housing 8 can contain metal or can be made of metal entirely. Note that the conductive gasket 9 will be described in detail later.

The first metal gear 1 is attached to one end of a shaft 4a of the motor main body 4, and engaged with the second metal gear 2. The second metal gear 2 rotates around the shaft part (second metal member) 2a as a rotation axis. This shaft part 2a is fixed on an inner surface of the first housing 8. The shaft part 2a itself does not rotate, but the second metal gear 2 is configured to be rotatable due to the presence of a bearing section 2b which is press-fit and fixed to the inside of the second metal gear 2 along the rotation axis. Further, the second metal gear 2 is also engaged with the third metal gear 3. The third metal gear 3 is attached to the shaft part 3a. Since the shaft part 3a is supported in a freely rotatable manner by the bearing sections 3b and 3c which are press-fit and fixed to the inside of side walls of the first housing 8, the third metal gear 3 rotates around the shaft part 3a as a rotation axis. Further, the bearing section 3c of the bearing sections 3b and 3c is arranged so as to be closer to a driver 5 which will be described later, and a portion of the bearing section 3c protrudes inside the first housing 8. The first metal gear 1, the second metal gear 2 and the third metal gear 3 function as a decelerating mechanism which reduces the speed of rotation of the motor main body 4 and transmits the rotation. The shaft part 3a functions as an output shaft for outputting ultimate rotation to the outside.

The servo horn 3d is attached to one end of the shaft part 3a on a side where the bearing section 3b is provided. Meanwhile, to the other end of the shaft part 3a, a magnet 3e is attached. The servo horn 3d is a part for transmitting rotation of the servo motor 100 to a movable part of a robot. The potentiometer 5a detects the magnetism of the magnet 3e which rotates together with the shaft part 3a, so that the potentiometer 5a figures out a rotation angle and transmits the rotation angle thus figured out to the driver 5.

The motor main body 4 includes the shaft 4a, a second housing (first metal member) 4b, a motor bearing sections 4c and 4d, a winding wire 4e and a rotor 4f. Further, inside the second housing 4b, the motor bearing section 4d, the winding wire 4e and the rotor 4f are contained. One end of the shaft 4a projects outside the second housing 4b, and rotates together with the rotor 4f. The motor bearing section 4c is attached to a side wall of the second housing 4b on a side where the one end of the shaft 4a projects outside the second housing 4b, such that a portion of the motor bearing section 4c protrudes outside the second housing 4b. Further, the second housing 4b has two outer surfaces parallel to a shaft center C of the shaft 4a. Each of the outer surfaces is in contact with an inner surface of the first housing 8. However, the arrangement of the outer surfaces of the second housing 4b is not limited to the arrangement described above. For example, the outer surfaces of the second housing 4b can be arranged such that at least one of the two outer surfaces of the second housing 4b is spaced apart from the inner surface of the first housing 8.

Moreover, as illustrated in FIG. 1, the servo motor 100 is connected with the driver 5 via a wiring 5b (the other end of the wiring 5b is connected to the winding wire 4e). The wiring 5b is used for transmitting, to the motor main body 4, a control signal (described later) which is transmitted from the driver 5. The driver 5 includes the potentiometer 5a, and is connected with a robot controller 7 via a control line 6. The driver 5 receives an input signal which has been transmitted via the control line 6 from the robot controller 7. This input signal is a signal related to a rotation angle and a rotation speed of the servo horn 3d. Further, the driver 5 also receives the output signal which has been transmitted from the potentiometer 5a. Then, the driver 5 compares an input value of the input signal and an output value of the output signal, and controls the rotation angle and the like of the servo horn 3d by transmitting the control signal to the motor main body 4 so that the output value will be equal to the input value.

(Configuration of Gear Structure 10)

The gear structure 10 is a structure provided in the servo motor 100 so as to stably eliminate high-frequency electromagnetic noise which is produced and emitted due to a contact between the first metal gear 1 and the second metal gear 2. The gear structure 10 eliminates high-frequency electromagnetic noise here by making the potential of the first metal gear 1 equal to the potential of the second metal gear 2.

The gear structure 10 is configured such that the second housing (first metal member) 4b electrically continuous with the first metal gear 1 and the shaft part (second metal member) 2a electrically continuous with the second metal gear 2 are electrically connected to each other by the conductive gasket (electrical connector) 9. More specifically, as illustrated in FIG. 1, the gear structure 10 includes the first metal gear 1, the second metal gear 2, the shaft part 2a, the bearing section 2b, the shaft 4a, the second housing 4b, the motor bearing section 4c and the conductive gasket 9

The conductive gasket 9 is a soft electrical coupling body which is intended to make the potential of the first metal gear 1 equal to the potential of the second metal gear 2. More specifically, the second housing 4b electrically continuous with the first metal gear 1 and the shaft part 2a electrically continuous with the second metal gear 2 are electrically connected to each other by use of the conductive gasket 9 as illustrated in FIG. 1, so that the potential of the first metal gear 1 equals to the potential of the second metal gear 2.

The conductive gasket 9 employed is a gasket that is obtained by molding, into an appropriate shape, a metal material having a spring property so that the shaft part 2a will be electrically connected with the second housing 4b. Examples of such a metal material include beryllium and copper. However, the conductive gasket 9 of the gear structure 10 is not limited to a case where a metal material as described above is used. For example, the gasket 9 can be made by covering the outside of a sponge-like or rubber-like core with a conductive material such as metal mesh, or alternatively can be made by molding, into an appropriate shape, a conductive elastomer (a material obtained by dispersing conductive particles or conductive fibers in a resin).

Note that other than the conductive gasket 9, it is possible to employ, as an electrical connector, any member that electrically connects the second housing 4b and the shaft part 2a to each other. For example, the shaft part 2a and the second housing 4b can be electrically connected to each other by a sheet metal.

Here, since the shaft 4a rotates and the motor bearing section 4c is attached to the second housing 4b, a connection between the shaft 4a and the motor bearing section 4c is not a complete electrical DC connection. However, since a gap between the shaft 4a and an insertion section (not illustrated) of the shaft 4a in the motor bearing section 4c is very small, high-frequency capacitive coupling occurs in the gap. Therefore, an electrical connection between the shaft 4a and the motor bearing section 4c is stable at high frequencies. On this account, the first metal gear 1, the shaft 4a, the motor bearing section 4c and the second housing 4b are electrically continuous with one another. Similarly, an electrical connection that is stable at high frequencies is also formed between the shaft part 2a and the bearing section 2b. Accordingly, the second metal gear 2, the bearing section 2b and the shaft part 2a are electrically continuous with one another.

In the above-described configuration, when the shaft part 2a and the second housing 4b are electrically connected to each other by use of the conductive gasket 9, all members constituting the gear structure 10 are electrically continuous with one other. As a result, the potential of the first metal gear 1 equals to the potential of the second metal gear 2. Therefore, even in a case where friction and/or an impact repeatedly occurs between teeth of the first metal gear 1 and teeth of the second metal gear 2 due to rotation of the shaft 4a, a current flow between the teeth of the first metal gear 1 and the teeth of the second metal gear 2 is eliminated. This consequently makes it possible to stably eliminate high-frequency electromagnetic noise.

<Significance of Gear Structure 10>

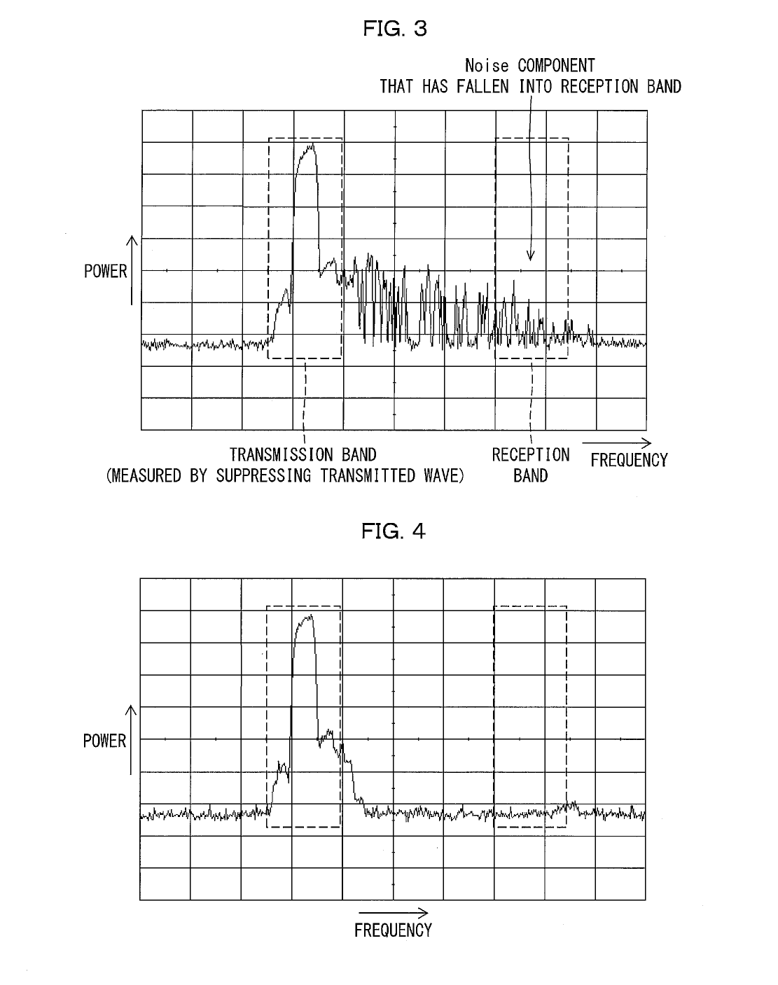

Next, the following will discuss the significance of including the gear structure 10 in the servo motor 100, with reference to FIGS. 2 to 4. FIG. 2 is a schematic view illustrating an example of an experiment for measuring high-frequency electromagnetic noise in a case where the servo motor is adjacent to a transmission antenna 900a of a communication device 900. FIG. 3 is a graph showing a spectral line of a communication wave 800 in a case where a servo motor 100a (not illustrated) without the gear structure 10 is employed. FIG. 4 is a graph showing a spectral line of a communication wave 800 in a case where the servo motor 100 with the gear structure 10 is employed. Note that the graphs of FIGS. 3 and 4 are each a graph displayed on a display screen of a spectrum analyzer 700 described later, and that in each of the graphs, a vertical axis represents power (unit: dBm), and a horizontal axis represents frequency (unit: MHz).

As illustrated in FIG. 2, the communication device 900 including the transmission antenna 900a transmits the communication wave 800 in a state in which the servo motor 100 or 100a is provided at a position adjacent to the transmission antenna 900a of the communication device 900. Then, the communication wave 800 thus transmitted is received by a measuring antenna 500, and only radio waves having frequencies in a range necessary for measurement is extracted by a reception-band band pass filter (BPF) 600. Then, a level of reception band noise in the measuring antenna 500 is measured by the spectrum analyzer 700. Note that the servo motor 100 or 100a is provided at a position adjacent to the transmission antenna 900a because a phenomenon in which high-frequency electromagnetic noise falls into the reception band of the measuring antenna 500 occurs prominently in a case where a noise source is provided adjacent to the transmission antenna 900a.

Note that in the above experiment, the communication device 900 is a cellular terminal which carries out an LTE (912.5 MHz) transmission at a transmission output of +23 dBm. Further, the measuring antenna 500 employed has a receiving sensitivity level that allows for receiving radio waves at approximately −100 dBm in a bandwidth of approximately 5 MHz. Further, the servo motor 100a which does not include the gear structure 10 and the servo motor 100 each have a motor rotation speed of 30000 rpm, and a gear ratio of 400:1.

First, in a case where the servo motor 100a which does not include the gear structure 10 of an embodiment of the present invention is used in the above experiment, the power indicated by the spectral line is large, as shown in FIG. 3, in the reception band of the measuring antenna 500 at high frequencies. The power is large in this case, because high-frequency electromagnetic noise which has been generated and emitted due to a contact between metal gears in the servo motor falls into the reception band. When actual communication is carried out in such circumstances, interference due to high-frequency electromagnetic noise occurs in a reception band of communication waves, and as a result, reception band noise is generated. Then, in a case where interference of reception due to the high-frequency electromagnetic noise continues for a long time, communication itself will be blocked.

On the other hand, in a case where the servo motor 100 which includes the gear structure 10 of an embodiment of the present invention is used in the above experiment, the power indicated by the spectral line is very small, as shown in FIG. 4, in the reception band of the measuring antenna 500 at high frequencies. The power is very small in this case, because an appropriate measure is taken by the gear structure 10 against a main source of high-frequency electromagnetic noise (that is, in the vicinity of a contact position between the teeth of the first metal gear 1 and the teeth of the second metal gear 2) and accordingly generation of high-frequency electromagnetic noise is eliminated. In this case, reception band noise is hardly generated in actual communication.

As described above, even when the servo motor 100 is adjacent to an antenna of a transmission-side communication device in a case where two communication devices are communicating with each other, an antenna of a reception-side communication device is hardly influenced by high-frequency electromagnetic noise because of the presence of the gear structure 10. Therefore, the gear structure 10 stably eliminates generation of reception band noise in a communication device. This is the significance of the gear structure 10.

<Effect of Gear Structure 10>

The first metal gear 1 and the second metal gear 2 are engaged with each other, and the first metal gear 1 rotates at a high speed. Accordingly, friction and/or an impact frequently occurs between the teeth of the first metal gear 1 and the teeth of the second metal gear 2. Therefore, a main source of high-frequency electromagnetic noise is in the vicinity of a position where the teeth of the first metal gear 1 and the teeth of the second metal gear 2 come in contact with each other.

In view of the above point, in Embodiment 1, the conductive gasket 9 electrically connects the second housing 4b and the shaft part 2a to each other. Accordingly, the potential of the first metal gear 1 equals to the potential of the second metal gear 2. This can eliminate a current flow in the vicinity of the position where the teeth of the first metal gear 1 and the teeth of the second metal gear 2 come in contact with each other. Therefore, an appropriate measure can be taken against a main source of high-frequency electromagnetic noise. This consequently makes it possible to eliminate generation of high-frequency electromagnetic noise more stably.

<Modified Example of Gear Structure 10>

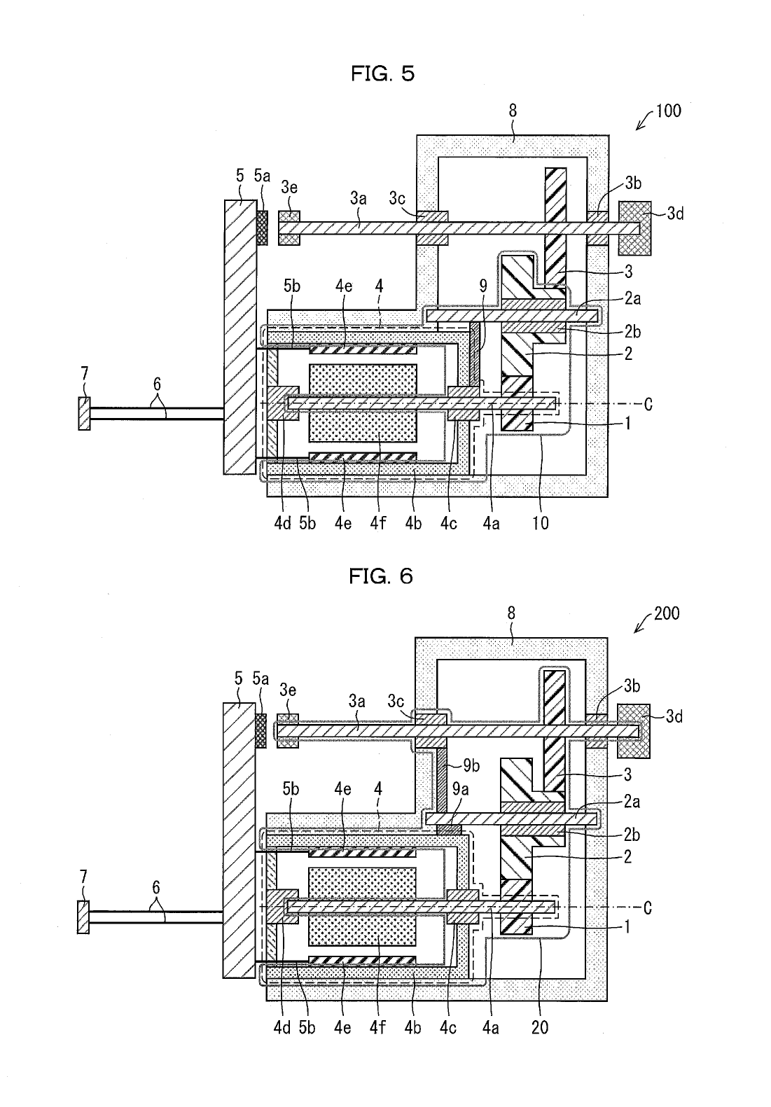

Note that the arrangement of the conductive gasket 9 included in the gear structure 10 is not limited to that in the case of Embodiment 1. Specifically, the first metal member electrically connected to the shaft part 2a by the conductive gasket 9 is not limited to the second housing 4b as described in Embodiment 1. For example, as illustrated in FIG. 5, the conductive gasket 9 can be arranged such that the motor bearing section 4c is the first metal member. Specifically, the motor bearing section 4c (a portion of the motor bearing section 4c, which portion is protruding on a side where the shaft 4a projects from the second housing 4b) and the shaft part 2a can be electrically connected to each other by the conductive gasket 9. Even in a case where the conductive gasket 9 is arranged as above, it is possible to obtain an effect similar to that in a case where the first metal member is the second housing 4b.

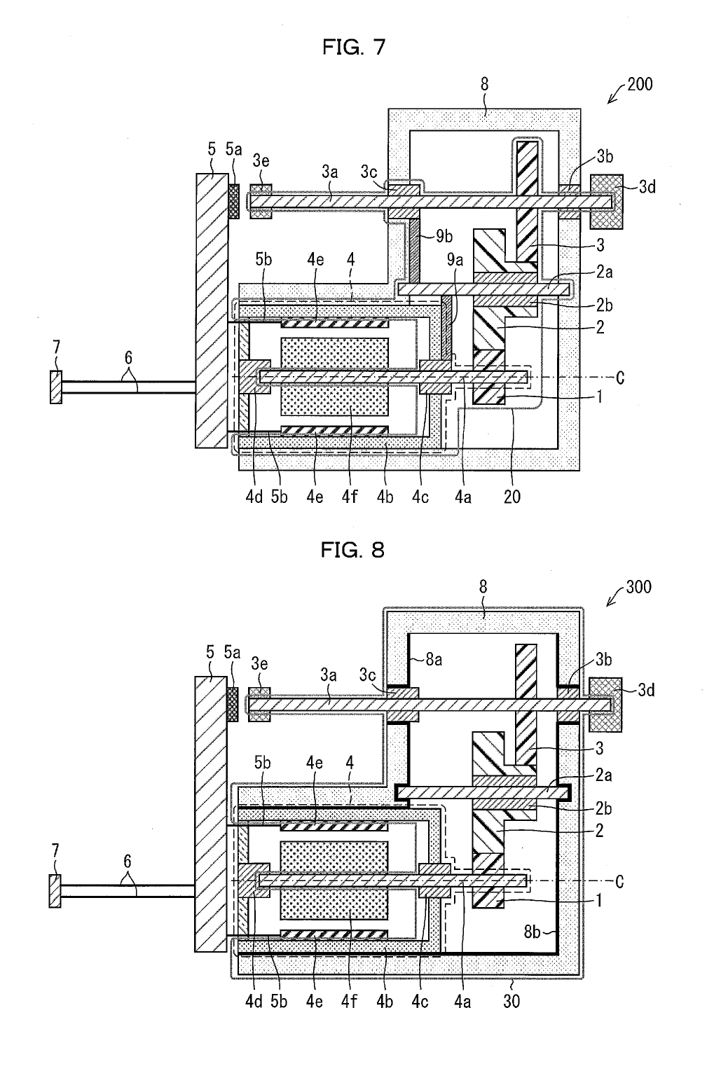

Further, the conductive gasket 9 can be used to make the potential of the second metal gear 2 equal to the potential of the third metal gear 3. Specifically, for example, the shaft part 2a and the bearing section 3c can be electrically connected to each other by the conductive gasket 9 (see FIGS. 6 and 7). Even in a case where a combination of metal gears made to have the same potential is configured as above, generation of high-frequency electromagnetic noise can be eliminated to a certain extent.

### Embodiment 2

The following description will discuss another embodiment of the present invention, with reference to FIGS. 6 and 7. Note that for convenience of explanation, each member having an identical function with a member described in Embodiment 1 is given an identical sign and an explanation thereof will be omitted.

A servo motor 200 in accordance with Embodiment 2 is different from the servo motor 100 in accordance with Embodiment 1 in that the servo motor 200 includes a gear structure 20 in place of the gear structure 10. The gear structure 20 is different from the gear structure 10 in accordance with Embodiment 1 in that the gear structure 20 includes a first conductive gasket (first electrical connector) 9a and a second conductive gasket (second electrical connector) 9b in place of the conductive gasket 9. Further, the gear structure 20 is different from the gear structure 10 in that the gear structure 20 further includes a third metal gear 3, a shaft part 3a and a bearing section 3c. Note that a configuration of the servo motor 200 is the same as that of the servo motor 100 except for inclusion of the first conductive gasket 9a and the second conductive gasket 9b in place of the conductive gasket 9, and therefore a description of the configuration of the servo motor 200 will be omitted here. Further, since the gear structure 20 has the same significance as the gear structure 10, a description of the significance of the gear structure 20 will be omitted here.

<Configuration of Gear Structure 20>

FIG. 6 is a cross sectional view illustrating a schematic configuration of the servo motor 200 in accordance with Embodiment 2 of the present invention. As illustrated in FIG. 6, the gear structure 20 includes a first metal gear 1, a second metal gear 2, a shaft part 2a, a bearing section 2b, the third metal gear 3, the shaft part 3a, the bearing section 3c, a shaft 4a, a second housing 4b, a motor bearing section 4c, the first conductive gasket 9a and the second conductive gasket 9b.

The first conductive gasket 9a, like the conductive gasket 9 of Embodiment 1, is a soft electrical coupling body which is intended to make the potential of the first metal gear equal to the potential of the second metal gear 2. Specifically, the first conductive gasket 9a forms an electrical connection between the second housing 4b electrically continuous with the first metal gear 1 and the shaft part 2a electrically continuous with the second metal gear 2. The second conductive gasket 9b is a soft electrical coupling body which is intended to make the potential of the second metal gear 2 equal to the potential of the third metal gear 3. Specifically, the second conductive gasket 9b electrically connects the shaft part 2a and a portion of the bearing section 3c (third metal member) to each other. This portion of the bearing 3c protrudes from an inner surface of the first housing 8. Further, the shaft part 2a is electrically continuous with the second metal gear 2, while the bearing section 3c is electrically continuous with the third metal gear 3. The above electrical connection makes the potential of the second metal gear 2 equal to the potential of the third metal gear 3.

Here, since the shaft part 3a rotates together with the third metal gear 3 and the bearing section 3c is attached to the first housing 8, a connection between the shaft part 3a and the bearing section 3c is not a complete electrical DC connection. However, since a gap between the shaft part 3a and an insertion section (not illustrated) of the shaft part 3a in the bearing section 3c is very small, high-frequency capacitive coupling occurs in the gap when the shaft part 3a rotates. Therefore, an electrical connection between the shaft part 3a and the bearing section 3c is stable at high frequencies. On this account, the third metal gear 3, the shaft part 3a and the bearing section 3c are electrically continuous with one another.

In the above-described configuration, the shaft part 2a and the second housing 4b are electrically connected to each other by the first conductive gasket 9a, while the shaft part 2a and the motor bearing section 4c are electrically connected to each other by the second conductive gasket 9b. As a result, all members constituting the gear structure 20 are electrically continuous with one another. Therefore, all the potential of the first metal gear 1, the potential of the second metal gear 2, and the potential of the third metal gear 3 are equal to one another.

Note that respective types and respective materials of the first conductive gasket 9a and the second conductive gasket 9b are the same as those of the conductive gasket 9 of Embodiment 1, and therefore, descriptions thereof will be omitted here. Further, as in the case of the conductive gasket 9 of Embodiment 1, a member other than the first conductive gasket 9a can be used as the first electrical connector, and a member other than the conductive gasket 9b can be used as the second electrical connector.

<Effect of Gear Structure 20>

Friction and/or an impact occurs to a certain extent between teeth of the second metal gear 2 and teeth of the third metal gear 3 due to a contact operation between the teeth of the second metal gear 2 and the teeth of the third metal gear 3, though the frequency of the occurrence of such friction and/or an impact is lower than that in the case of a contact operation between teeth of the first metal gear 1 and the teeth of the second metal gear 2. Accordingly, even when a potential difference occurs between the second metal gear 2 and the third metal gear 3, a certain level of high-frequency electromagnetic noise is generated in the vicinity of a position where the teeth of the second metal gear 2 and the teeth of the third metal gear 3 come in contact with each other.

In this regard, in Embodiment 2, the first conductive gasket 9a electrically connects the second housing 4b and the shaft part 2a to each other. Further, the second conductive gasket 9b electrically connects the bearing section 3c and the shaft part 2a to each other. Therefore, when the second conductive gasket 9b is used to make the potential of the second metal gear 2 equal to the potential of the third metal gear 3, a more effective measure can be taken against high-frequency electromagnetic noise as compared to a case where only the potential of the first metal gear 1 is made to be equal to the potential of the second metal gear 2. This makes it possible to more stably eliminate generation of high-frequency electromagnetic noise.

<Modified Example of Gear Structure 20>

Note that the arrangement of the first conductive gasket 9a included in the gear structure 20 is not limited to that in the case of Embodiment 2. Specifically, the first metal member electrically connected to the shaft part 2a by the first conductive gasket 9a is not limited to the second housing 4b as described in Embodiment 2. For example, as illustrated in FIG. 7, the first conductive gasket 9a can be arranged such that the motor bearing section 4c is the first metal member. Specifically, the motor bearing section 4c (a portion of the motor bearing section 4c, which portion is protruding on a side where the shaft 4a projects from the second housing 4b) and the shaft part 2a can be electrically connected to each other by the first conductive gasket 9a.

Further, the arrangement of the second conductive gasket 9b included in the gear structure 20 is not limited to that in the case of Embodiment 2. Specifically, the third metal member electrically connected to the shaft part 2a by the second conductive gasket 9b is not limited to the bearing section 3c as described in Embodiment 2. For example, though not illustrated, the second conductive gasket 9b can be arranged such that the bearing section 3b is the third metal member. Specifically, it is possible to have a configuration in which the bearing section 3b is arranged to have a portion which protrudes on an inner surface side of the first housing 8, and this portion and the shaft part 2a are electrically connected to each other by the second conductive gasket 9b.

Even when the first conductive gasket 9a is arranged as above, it is possible to obtain an effect similar to that in a case where the first metal member is the second housing 4b. Further, even when the second conductive gasket 9b is arranged as above, it is possible to obtain an effect similar to that in a case where the third metal member is the bearing section 3c.

### Embodiment 3

The following description will discuss still another embodiment of the present invention, with reference to FIG. 8. Note that for convenience of explanation, each member having an identical function with a member described in Embodiment 1 or 2 is given an identical sign and an explanation thereof will be omitted.

A servo motor 300 in accordance with Embodiment 3 is different from each of the servo motors 100 and 200 in accordance with respective Embodiments 1 and 2 in that the servo motor 300 includes a gear structure 30 in place of the gear structure 10 or 20. The gear structure 30 is different from the gear structures 10 and 20 in accordance with respective Embodiments 1 and 2 in that the gear structure 30 employs, as electrical connectors, metal-plated inner surfaces (conductive surfaces of the first housing) 8a and 8b in place of the conductive gasket 9, the first conductive gasket 9a and the second conductive gasket 9b. Further, the gear structure 30 is different from the gear structure 10 in that the gear structure 30 further includes a third metal gear 3, a shaft part 3a and a bearing section 3c. Note that a configuration of the servo motor 300 is the same as those of the servo motors 100 and 200 except that the servo motor 300 includes none of the conductive gasket 9, the first conductive gasket 9a and the second conductive gasket 9b, and therefore, an explanation of the configuration of the servo motor 300 will be omitted here. Further, since the gear structure 30 has the same significance as the gear structures 10 and 20, a description of the significance will be omitted here.

<Configuration of Gear Structure 30>

FIG. 8 is a cross sectional view illustrating a schematic configuration of the servo motor 300 in accordance with Embodiment 3 of the present invention. As illustrated in FIG. 8, the gear structure 30 includes a first metal gear 1, a second metal gear 2, a shaft part 2a, a bearing section 2b, the third metal gear 3, the shaft part 3a, the bearing section 3c, a shaft 4a, a second housing 4b, a motor bearing section 4c, and a first housing 8.

In the gear structure 30, the metal-plated inner surfaces 8a and 8b (conductive surfaces) of the first housing 8 each serve the same role as an electrical connector (the conductive gasket 9, the first conductive gasket 9a and the second conductive gasket 9b). That is, the shaft part 2a is fixed to the inner surfaces 8a and 8b, and the bearing sections 3b and 3c are press-fit and fixed to the inner surfaces 8b and 8a, respectively. Further, the inner surfaces 8a and 8b are in contact with two outer surfaces of the second housing 4b, which two outer surfaces are parallel to the shaft center C of the shaft 4a. Accordingly, all of the inner surfaces (electrical connector) 8a and 8b of the first housing, which inner surfaces are conductive, the second housing (first metal member) 4b, the shaft 4a, the first metal gear 1, the second metal gear 2, the shaft part (second metal member) 2a, the bearing section (third metal member) 3c and the third metal gear 3 are electrically continuous with one another. Therefore, all of the first metal gear 1, the second metal gear 2 and the third metal gear 3 can be made to have the same potential.

Note that a method of supporting the shaft parts 2a and 3a is not limited to the above case of Embodiment 3. For example, though not illustrated, the shaft part 2a which rotates can be supported by press-fitting and inserting a metal bearing section in each of the inner surfaces 8a and 8b of the first housing 8 in a case where the shaft part 2a rotates together with the second metal gear 2. Alternatively, though not illustrated, the shaft part 3a can be fixed to the inner surfaces 8a and 8b of the first housing 8 (in this case, the third metal gear 3 is arranged to be rotatable by providing a metal bearing section in the third metal gear 3). Even in cases where any of the above methods are employed, all of the first metal gear 1, the second metal gear 2, and the third metal gear 3 can be made to have the same potential.

Further, the shape of the first housing 8 is also not limited to that in the case of Embodiment 3. Note however that it is necessary to employ, in accordance with the shape of the first housing 8, a method of supporting the shaft parts 2a and 3a and an arrangement of the second housing 4b so that all of the first metal gear 1, the second metal gear 2, and the third metal gear 3 will have the same potential.

<Effect of Gear Structure 30>

As described above, Embodiment 3 can make all the first metal gear 1, the second metal gear 2, and the third metal gear 3 to have the same potential, by plating, with metal, a portion of the inner surfaces of the first housing 8 but providing no separate member as an electrical connector. As a result, an effective measure can be taken against high-frequency electromagnetic noise by use of a simple configuration. This makes it possible to more stably eliminate generation of high-frequency electromagnetic noise.

<Modified Example of Gear Structure 30>

Note that in regard to the metal-plated inner surfaces of the first housing 8, it is not necessary to plate both inner surfaces 8a and 8b with metal, but it is only necessary to plate, with metal, at least either one of the inner surfaces 8a and 8b of the first housing 8. Further, it is possible to have a configuration in which only a portion (in the vicinity of a position where the second housing 4b and the shaft part 2a are in contact with each other) of at least either one of the above inner surfaces 8a or 8b is metal-plated (not illustrated) such that the second housing (first metal member) 4b and the shaft part (second metal member) 2a are electrically connected to each other. This applies to a case where the second housing 4b and the bearing section (third metal member) 3c are electrically connected to each other, and to a case where the shaft part 2a and the bearing section 3c are electrically connected to each other.

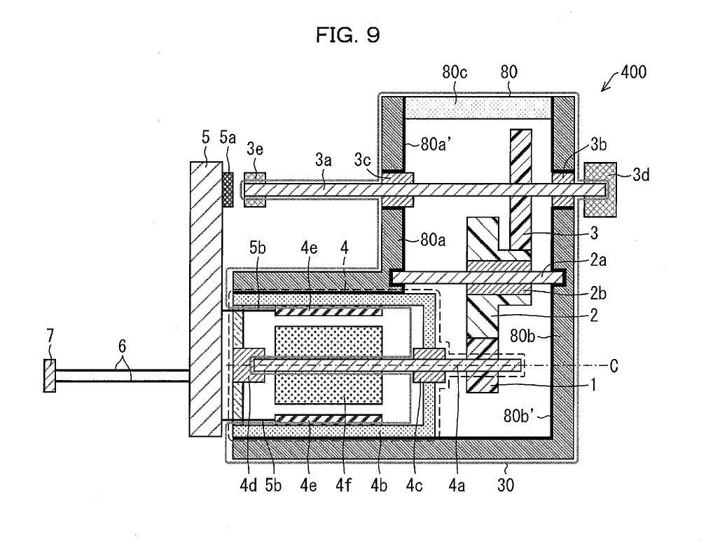

Further, a method of imparting conductivity to a portion of an inner surface(s) of the first housing 8 is not limited to the above case of Embodiment 3. For example, it is possible to employ a servo motor 400 including a first housing 80, as illustrated in FIG. 9, in place of the first housing 8. The first housing 80 includes a resin part 80c, a metal part 80a, and another metal part 80b. Then, all of the second housing 4b, the shaft part 2a and the bearing section 3c can be arranged to be in contact with at least one of an inner surface 80a′ of the metal part 80a and an inner surface 80b′ of the metal part 80b. In this case, at least either one of the inner surfaces 80a′ and 80b′ (conductive surfaces of the first housing) serves as an electrical connector. Furthermore, the first housing 80 can include metal parts 80a and 80b (not illustrated) which have respective shapes that allow the second housing 4b and the shaft part 2a to be electrically connected to each other. In this case, the bearing section 3c is not electrically connected with the second housing 4b and the shaft part 2a, and the resin part 80c is arranged to have a shape with which the resin part 80c is in contact with the bearing section 3c (not illustrated).

In this case, it is also possible to have a configuration in which at least either one of the metal parts 80a and 80b is made of metal (not illustrated) so that the second housing (first metal member) 4b and the shaft part (second metal member) 2a will be electrically connected to each other. The same applies to a case where the second housing 4b and the bearing section (third metal member) 3c are electrically connected to each other, and to a case where the shaft part 2a and the bearing section 3c are electrically connected to each other.

[Main Points]

A gear structure (10, 20) in accordance with Aspect 1 of the present invention includes: a first metal gear (1) contained in a first housing (8); a second metal gear (2) that rotates in conjunction with the first metal gear in the first housing; a first metal member (second housing 4b, motor bearing section 4c) electrically continuous with the first metal gear; a second metal member (shaft part 2a) electrically continuous with the second metal gear; and an electrical connector (conductive gasket 9, first conductive gasket 9a, second conductive gasket 9b) electrically connecting the first metal member and the second metal member to each other.

In the above configuration, the electrical connector forms an electrical connection between the first metal member electrically continuous with the first metal gear and the second metal member electrically continuous with the second metal gear. This makes the potential of the first metal gear equal to the potential of the second metal gear.

Therefore, a current flow can be eliminated between the first metal gear and the second metal gear engaged with each other even in a case where the first metal gear and the second metal gear rotate in conjunction with each other and friction and/or an impact repeatedly occurs between teeth of the first metal gear and teeth of the second metal gear. This makes it possible to stably eliminate high-frequency electromagnetic noise which is generated and emitted due to a contact between the teeth of the first metal gear and the teeth of the second metal gear.

A gear structure (10, 20) in accordance with Aspect 2 of the present invention can be configured such that in the above Aspect 1, the first metal gear is attached to a shaft (4a) of a motor main body (4) contained in the first housing, and is engaged with the second metal gear; the first metal member is electrically continuous with the shaft; and the second metal member is a shaft part (2a) serving as a rotation axis of the second metal gear.

The first metal gear and the second metal gear are engaged with each other and the first metal gear is rotated at a high speed by the motor main body, so that friction and/or an impact frequently occurs between the teeth of the first metal gear and the teeth of the second metal gear. Therefore, a main source of high-frequency electromagnetic noise is the vicinity of a position where the teeth of the first metal gear and the teeth of the second metal gear come in contact with each other.

In this regard, in the above configuration, the electrical connector forms an electrical connection between the first metal member electrically continuous with the shaft and the shaft part serving as a rotation axis of the second metal gear. Accordingly, the potential of the first metal gear equals to the potential of the second metal gear. This makes it possible to eliminate a current flow in the vicinity of the position where the teeth of the first metal gear and the teeth of the second metal gear come in contact with each other. This makes it possible to take an appropriate measure against the main source of high-frequency electromagnetic noise and consequently to more stably eliminate generation of high-frequency electromagnetic noise.

A gear structure (20) in accordance with Aspect 3 of the present invention can be configured such that: in the above Aspect 2, the electrical connector (first conductive gasket 9a, second conductive gasket 9b) includes a first electrical connector (first conductive gasket 9a) and a second electrical connector (second conductive gasket 9b); the first housing further contains a third metal gear (3) engaged with the second metal gear; the third metal gear is electrically continuous with a third metal member (bearing section 3c); the first electrical connector electrically connects the shaft part and the first metal member to each other; and the second electrical connector electrically connects the shaft part and the third metal member to each other.

Friction and/or an impact occurs to a certain extent between the teeth of the second metal gear and teeth of the third metal gear due to a contact operation between the teeth of the second metal gear and the teeth of the third metal gear, though the frequency of the occurrence of such friction and/or an impact is lower than that in the case of a contact operation between the teeth of the first metal gear and the teeth of the second metal gear. Accordingly, even when a potential difference occurs between the second metal gear and the third metal gear, a certain level of high-frequency electromagnetic noise is generated in the vicinity of a position where the teeth of the second metal gear and the teeth of the third metal gear come in contact with each other.

In this regard, in the above configuration, the first electrical connector forms an electrical connection between the first metal member electrically continuous with the shaft and the shaft part to which the second metal gear is attached. Further, second electrical connector forms an electrical connection between the shaft part and the third metal member electrically continuous with the third metal gear. Therefore, when the second electrical connector is used to make the potential of the second metal gear equal to the potential of the third metal gear, a more effective measure can be taken against high-frequency electromagnetic noise as compared to a case where only the potential of the first metal gear is made to be equal to the potential of the second metal gear. This makes it possible to more stably eliminate generation of high-frequency electromagnetic noise.

A gear structure (10, 20) in accordance with Aspect 4 of the present invention can be configured such that in any one of the above Aspects 1 to 3, the first housing contains a resin as a material of the first housing.

The above configuration makes it possible to reduce the weight and the cost of a servo motor as compared to a case where the first housing is made of only metal. Therefore, the gear structure makes it possible to reduce the weight and the cost of a servo motor and at the same time to stably eliminate generation of high-frequency electromagnetic noise.

A gear structure (30) in accordance with Aspect 5 of the present invention can be arranged such that: in the above Aspect 1, the first housing has a conductive surface (8a, 8b, 80a′, 80b′) which is in contact with the first metal member and the second metal member; and the electrical connector (8a, 8b, 80a′, 80b′) is the conductive surface of the first housing.

In the above configuration, all of the conductive surface of the first housing, the second housing (first metal member) made of metal, the shaft, the first metal gear, the second metal gear and the shaft part (second metal member) made of metal are made to be electrically continuous with one another by the conductive surface (electrical connector) of the first housing. This can make the potential of the first metal gear equal to the potential of the second metal gear. This consequently makes it possible to stably eliminate high-frequency electromagnetic noise generated in the vicinity of the position where the teeth of the first metal gear and the teeth of the second metal gear come in contact with each other.

A gear structure in accordance with Aspect 6 of the present invention can be arranged such that: in the above Aspect 5, the first housing further contains a third metal gear (3) engaged with the second metal gear; the conductive surface of the first housing is further in contact with a third metal member (bearing section 3c) which is electrically continuous with the third metal gear; and the conductive surface of the first housing further electrically connects the third metal member and the second metal member to each other.

In the above configuration, the third metal member and the third metal gear are further made to be electrically continuous with each other by the conductive surface (electrical connector) of the first housing. This can make the potential of the second metal gear equal to the potential of the third metal gear, in addition to making the potential of the first metal gear equal to the potential of the second metal gear. This consequently makes it possible to more stably eliminate high-frequency electromagnetic noise.

A servo motor (100, 200, 300) in accordance with an aspect 7 of the present invention can include the gear structure (10, 20, 30) in accordance with any one of the above-described Aspects 1 to 6.

The above configuration can make it possible to take an appropriate measure against a source of high-frequency electromagnetic noise and therefore, can provide a servo motor capable of stably eliminating high-frequency electromagnetic noise.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### INDUSTRIAL APPLICABILITY

The present invention is applicable to servo motors in general each including a metal gear.

### REFERENCE SIGNS LIST

1 first metal gear
2 second metal gear
2a shaft part (second metal member)
3 third metal gear
3c bearing section (third metal member)
4 motor main body
4a shaft
4b second housing (first metal member)
4c motor bearing section (first metal member)
8, 80 first housing
8a, 8b, 80a′, 80b′ inner surface (conductive surface of first housing, electrical connector)
9 conductive gasket (electrical connector)
9a first conductive gasket (first electrical connector)
9b second conductive gasket (second electrical connector)
10, 20, 30 gear structure
100, 200, 300, 400 servo motor

1. A gear structure comprising:
a first metal gear contained in a first housing;
a second metal gear that rotates in conjunction with the first metal gear in the first housing;
a first metal member electrically continuous with the first metal gear;
a second metal member electrically continuous with the second metal gear; and
an electrical connector electrically connecting the first metal member and the second metal member to each other.

2. The gear structure as set forth in claim 1 wherein:
the first metal gear is attached to a shaft of a motor main body contained in the first housing, and is engaged with the second metal gear;
the first metal member is electrically continuous with the shaft; and
the second metal member is a shaft part serving as a rotation axis of the second metal gear.

3. The gear structure as set forth in claim 2 wherein:
the electrical connector includes a first electrical connector and a second electrical connector;
the first housing further contains a third metal gear engaged with the second metal gear;
the third metal gear is electrically continuous with a third metal member;
the first electrical connector electrically connects the shaft part and the first metal member to each other; and
the second electrical connector electrically connects the shaft part and the third metal member to each other.

4. The gear structure as set forth in claim 1, wherein:
the first housing contains a resin as a material of the first housing.

5. The gear structure as set forth in claim 1 wherein:
the first housing has a conductive surface which is in contact with the first metal member and the second metal member; and
the electrical connector is the conductive surface of the first housing.

6. The gear structure as set forth in claim 5 wherein:
the first housing further contains a third metal gear engaged with the second metal gear;
the conductive surface of the first housing is further in contact with a third metal member which is electrically continuous with the third metal gear; and
the conductive surface of the first housing further electrically connects the third metal member and the second metal member to each other.

7. A servo motor comprising the gear structure as set forth in claim 1.
